(19) United States
(12) Patent Application Publication
(10) Pub. No.: US 2026/0315846 A1
(43) Pub. Date: Oct. 15, 2026

(54) UTILIZING A ROBOTIC FIREFIGHTING VEHICLE CAMERA ASSEMBLY

(71) Applicant: Howe & Howe Inc., Waterboro, ME (US)

(72) Inventors: Timothy Merlin Foley, Lyman, ME (US); Jesse Morrill, Standish, ME (US)

(21) Appl. No.: 19/631,003

(22) Filed: Mar. 27, 2026

Related U.S. Application Data
(60) Provisional application No. 63/786,570, filed on Apr. 10, 2025.

(51) Int. Cl. A62C 27/00; A62C 37/36

(52) U.S. Cl. CPC A62C 27/00; A62C 37/36

(57) ABSTRACT

A robotic firefighting vehicle includes a robotic firefighting vehicle body, and a propulsion system coupled with the robotic firefighting vehicle body. The propulsion system is constructed and arranged to provide propulsion to the robotic firefighting vehicle. The robotic firefighting vehicle further includes a robotic firefighting vehicle camera assembly coupled with the robotic firefighting vehicle body. The robotic firefighting vehicle camera assembly includes a camera housing constructed and arranged to attach to the robotic firefighting vehicle body, and a movable camera coupled with the camera housing, the movable camera being constructed and arranged to move relative to the camera housing. The robotic firefighting vehicle camera assembly further includes a debris shield constructed and arranged to position over the movable camera and the camera housing to protect against debris damage when the camera housing attaches to the robotic firefighting vehicle body.

### CROSS REFERENCE TO RELATED APPLICATIONS

This application is a regular utility application based on earlier-filed U.S. Application No. 63/786,570 filed on Apr. 10, 2025, entitled "Utilizing a Robotic Firefighting Vehicle Camera Assembly", the contents and teachings of which are hereby incorporated by reference in their entirety.

### TECHNICAL FIELD

This disclosure relates generally to firefighting apparatus, and more particularly to utilizing a movable camera on firefighting equipment such as a firefighting robotic vehicle.

### BACKGROUND

A conventional firefighting robotic vehicle includes a fixed forward-facing camera fastened to the vehicle chassis. The fixed forward-facing camera provides a view of what is in front of the vehicle.

During operation, a human operator uses a remote control interface from a safe distance to robotically drive the firefighting robotic vehicle forward toward a burning target (e.g., to spray water or foam over the burning target). While the human operator drives the firefighting robotic vehicle forward, the human operator is able to use the fixed forward-facing camera to view what is in front of the vehicle even if the vehicle is no longer within line of sight of the human operator. Accordingly, the human operator is able to avoid driving the firefighting robotic vehicle into or over obstacles in front of the vehicle such as bushes, piles of debris, other obstructions, and so on.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of a robotic firefighting vehicle which is equipped with a pan, tilt, zoom (PTZ) camera assembly in accordance with one or more embodiments.

FIG. 2 is an exploded view of certain componentry of the robotic firefighting vehicle in accordance with one or more embodiments.

FIG. 3 is a close-up view of certain componentry of the robotic firefighting vehicle in accordance with one or more embodiments.

FIG. 4 is a schematic view of certain componentry of the robotic firefighting vehicle in accordance with one or more embodiments.

FIG. 5 is a perspective view of a cover of the PTZ assembly in accordance with one or more embodiments.

FIG. 6 is a front view of the cover of the PTZ assembly in accordance with one or more embodiments.

FIG. 7 is a top view of the cover of the PTZ assembly in accordance with one or more embodiments.

FIG. 8 is a side view of the cover of the PTZ assembly in accordance with one or more embodiments.

### DETAILED DESCRIPTION

Although a conventional firefighting robotic vehicle that includes a fixed forward-facing camera fastened to the vehicle chassis may provide a view of what is in front of the vehicle, it may be advantageous to have access to other views. Along these lines, the human operator may not be able to effectively view what is on the left or right sides of the vehicle, above the vehicle, in the distance, etc. However, if such other views were available, the human operator may be able to perform other beneficial operations.

For example, during an emergency, suppose that the vehicle is delivering fluid to a burning target in front of the vehicle but that a second target out of view of the fixed forward-facing camera just to the left or right of the vehicle has started to burn. Unfortunately, if the vehicle is no longer in the human operator’s direct line of sight, the human operator may not be aware that the vehicle is now in jeopardy and, thus, risk losing the vehicle. To avoid such a risk, the human operator could occasionally steer the vehicle to the left and right, but such left and right steering simply to view what is on the vehicle sides would sacrifice critical time that could otherwise be used to address other issues during the emergency.

As another example, suppose that the vehicle has entered a burning warehouse and is headed toward a burning target on the warehouse floor. It would be useful for the human operator to know if there are any fires or related dangers in the ceiling to avoid falling debris that could perhaps damage or disable the vehicle (e.g., destroy the camera). However, if the ceiling is out of view of the fixed forward-facing camera, the human operator would not know if there is a high risk or little risk of falling debris.

As yet another example, there could be certain details that are too small for the human operator to discern using the fixed forward-facing camera. For example, there could be hazardous materials stored in the next room ahead but the human operator may be unable to discern presence of these materials simply using the fixed forward-facing camera.

At this point, it should be appreciated that the view provided by the fixed forward-facing camera of the firefighting robotic vehicle is limited and that it may be advantageous to have access to other views. As an option, a camera could be added to a fire monitor which can be aimed to spray water or foam toward a burning target, but the view from the camera could be blocked by the spray and the direction of that view would be dependent on the direction of the fire monitor. What is needed, therefore, is a way for a firefighting robotic vehicle to provide views other than those simply from a fixed forward-facing camera or a camera added to a fire monitor.

The above need is addressed at least in part by utilizing a robotic firefighting vehicle camera assembly having a movable camera. Along these lines, such a movable camera may be coupled to a body of a robotic firefighting vehicle and protected by a debris shield. For example, the movable camera may be provisioned with pan, tilt, zoom (PTZ) operability and put in place of a fixed forward-facing camera. Accordingly, the movable camera is able to provide views to the left or right of the vehicle (e.g., via panning) thus enabling a user interface to provide a view of what is off to the side without needed to change the direction of the vehicle. Additionally, the movable camera is able to view what is above the vehicle or on the ground just in front of the vehicle (e.g., via tilting) thus enabling the user interface to provide images of areas such as a ceiling, tree limb, etc. immediately above the vehicle while receiving protection from the debris shield, or pits/holes/trenches/etc. in the ground immediately in front of the vehicle, and so on. Furthermore, the movable camera is able to view more distant details that could be otherwise missed (e.g., via zooming) such as people, hazardous materials, various problematic structures, combinations thereof, etc. beyond the immediate foreground. As a result, the robotic firefighting vehicle camera assembly provides improved situational awareness to enhance operation of the robotic firefighting vehicle.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

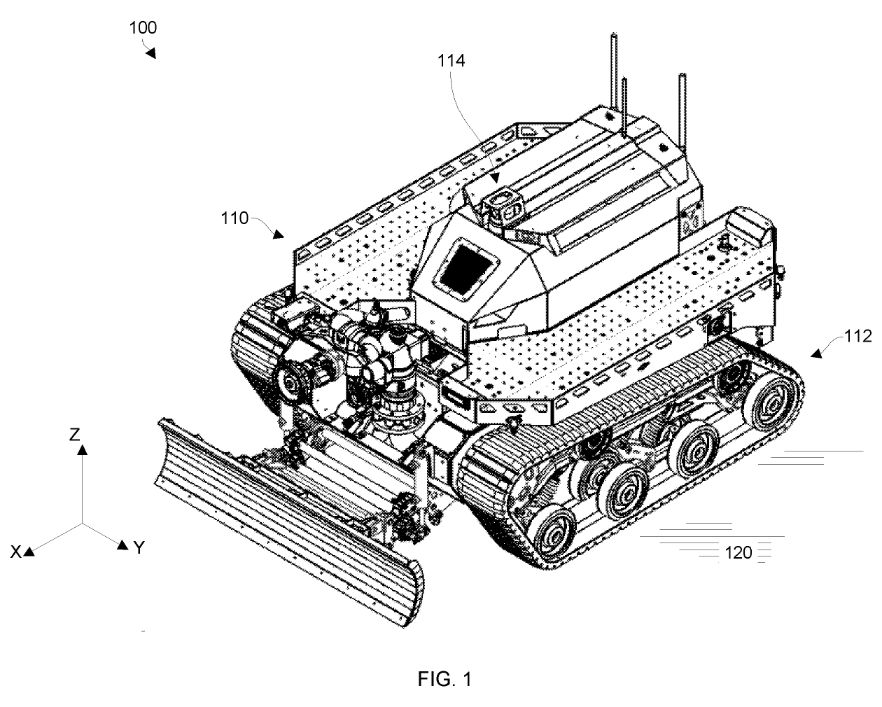

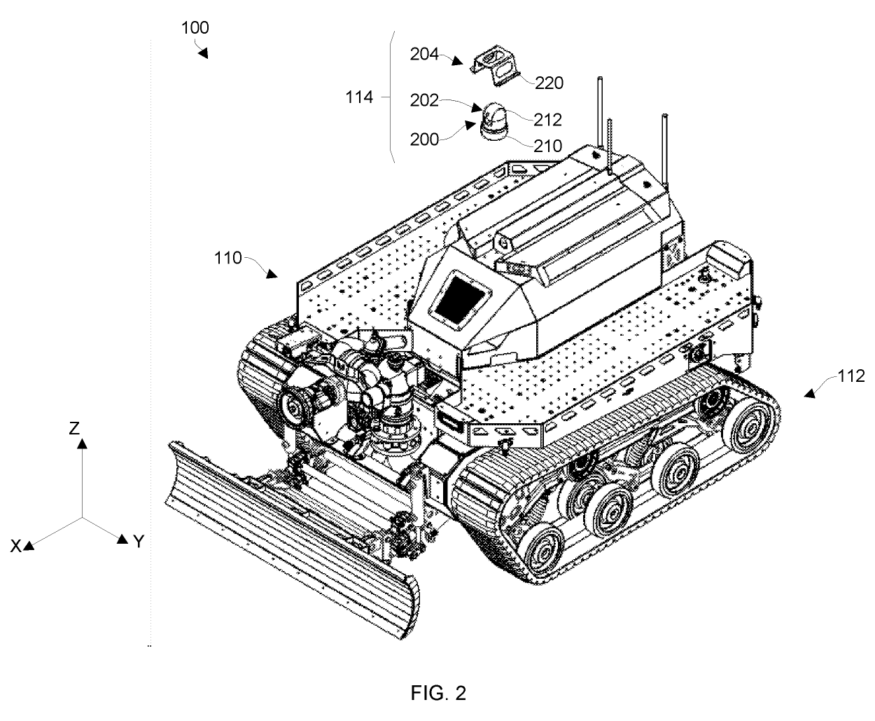

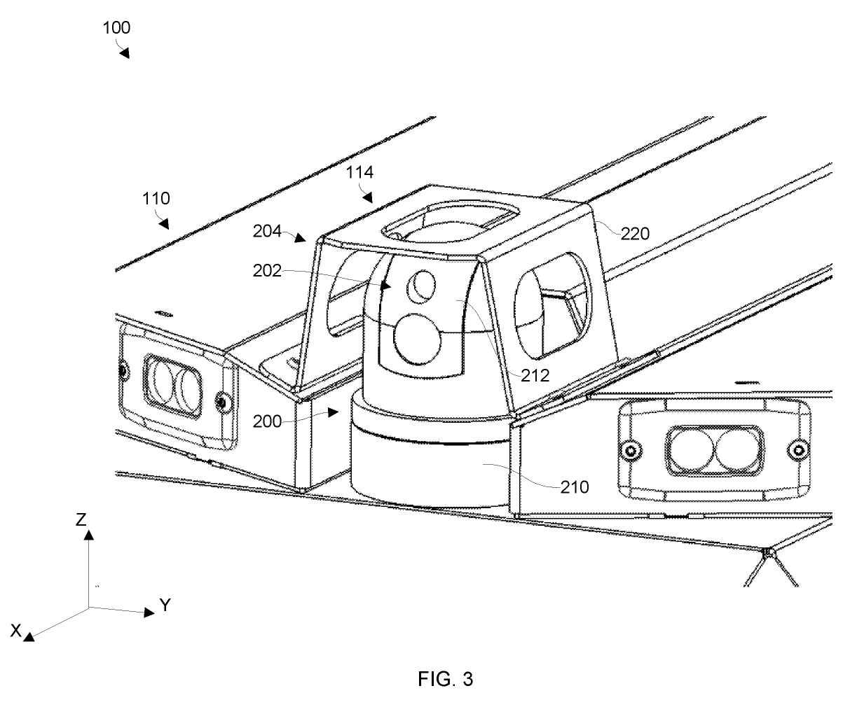

FIGS. 1-3 show a robotic firefighting vehicle 100 which is equipped with a movable camera in accordance with one or more embodiments. FIG. 1 is a perspective view of the robotic firefighting vehicle 100. FIG. 2 is an exploded view of the robotic firefighting vehicle 100. FIG. 3 is a close-up view of certain componentry of the robotic firefighting vehicle 100. As shown in FIGS. 1 and 2, the robotic firefighting vehicle 100 includes a robotic firefighting vehicle body 110, a propulsion system 112, and a robotic firefighting vehicle camera assembly 114.

The robotic firefighting vehicle body 110 is constructed and arranged to serve as a firefighting platform. Along these lines, the robotic firefighting vehicle body 110 provides a durable structure that supports various types of firefighting equipment such as a fire monitor to deliver fluid (e.g., water, foam, etc.) onto a burning target, a front end attachment (e.g., a plow, forks, etc.), a set of cargo baskets for carrying various apparatus (e.g., a tank, fire hoses, etc.), and so on. The robotic firefighting vehicle body 110 also carries internal equipment such as control circuitry, plumbing/piping which serves as a conduit to connect a set of fire hoses to the fire monitor, etc.

The propulsion system 112 couples with the robotic firefighting vehicle body 110, and is constructed and arranged to provide vehicle propulsion (e.g., drive, steering, etc.). Along these lines, the propulsion system may include ground engaging members (e.g., a set of tracks, tires, combinations thereof, etc.) which are driven by one or more engines, motors, combinations thereof, etc. to maneuver the robotic firefighting vehicle 100 within an environment 120. In particular, control circuitry within the robotic firefighting vehicle body 110 may receive wireless commands from a remote user, and operate the propulsion system 112 in response to the wireless commands.

The robotic firefighting vehicle camera assembly 114 is constructed and arranged to attach to the robotic firefighting vehicle body 110 and provide camera signals to remote equipment enabling a remote user to acquire an improved situational awareness of the environment 120. Along these lines, the robotic firefighting vehicle camera assembly 114 includes a movable camera (e.g., a PTZ camera equipped with visual sensing, thermal imaging, and infrared sensing) which is able to capture and convey details of the surrounding environment 120 to the remote equipment. In some arrangements, the movable camera communicates through the same central controller as that which is used to operate the propulsion system 112.

During operation, the robotic firefighting vehicle 100 performs firefighting operations. Along these lines, while a backend of the robotic firefighting vehicle 100 connects with a fluid supply (e.g., via fire hoses), the propulsion system 112 may drive the robotic firefighting vehicle 100 toward a burning target. Additionally, a fire monitor on the frontend of the robotic firefighting vehicle 100 may deliver fluid toward the burning target. Both steering of the robotic firefighting vehicle 100 and aiming of the fire monitor to deliver the fluid toward the burning target may be controlled remotely through the central controller via a remote user interface (e.g., a joystick and electronic displays, a tablet device, etc.).

During such operation, the movable camera of the robotic firefighting vehicle camera assembly 114 may capture displayable views of the environment and convey the displayable views, in the form of electronic signals, to the user interface. Accordingly, a remote user is able to enjoy enhanced situational awareness and effectively operate the robotic firefighting vehicle 100 even if the robotic firefighting vehicle 100 is no longer in the user’s direct line of sight.

Moreover, as will be explained in further detail shortly, the movable camera may be equipped with pan, tilt, zoom operability. Accordingly, the robotic firefighting vehicle camera assembly 114 is able to let the user see what is on the left and right sides of the vehicle 100, what is above the vehicle 100, what is in the distance, and so on. As a result, the user is able to remotely operate the vehicle 100 without having to steer the vehicle 100 in certain directions to see to the left or right, etc. and the user has better awareness of the situation.

As best seen in FIGS. 2 and 3, the robotic firefighting vehicle camera assembly 114 includes a camera housing 200, a movable camera 202, and a debris shield 204. The camera housing 200 is constructed and arranged to attach to the robotic firefighting vehicle body 110 (e.g., via hardware). The movable camera 202 is coupled with the camera housing 200, and is constructed and arranged to move relative to the camera housing 200. The debris shield 204 is constructed and arranged to position over the movable camera 202 and the camera housing 200 to protect against debris damage when the camera housing 200 attaches to the robotic firefighting vehicle body 110.

In some arrangements, the camera housing 200 includes a base 210 and a translucent cover 212 (e.g., a transparent dome, a transparent plate or lens, etc.). The base 210 is constructed and arranged to mount to the robotic firefighting vehicle body 110. The translucent cover 212 couples with the base 210 and encloses the movable camera 202.

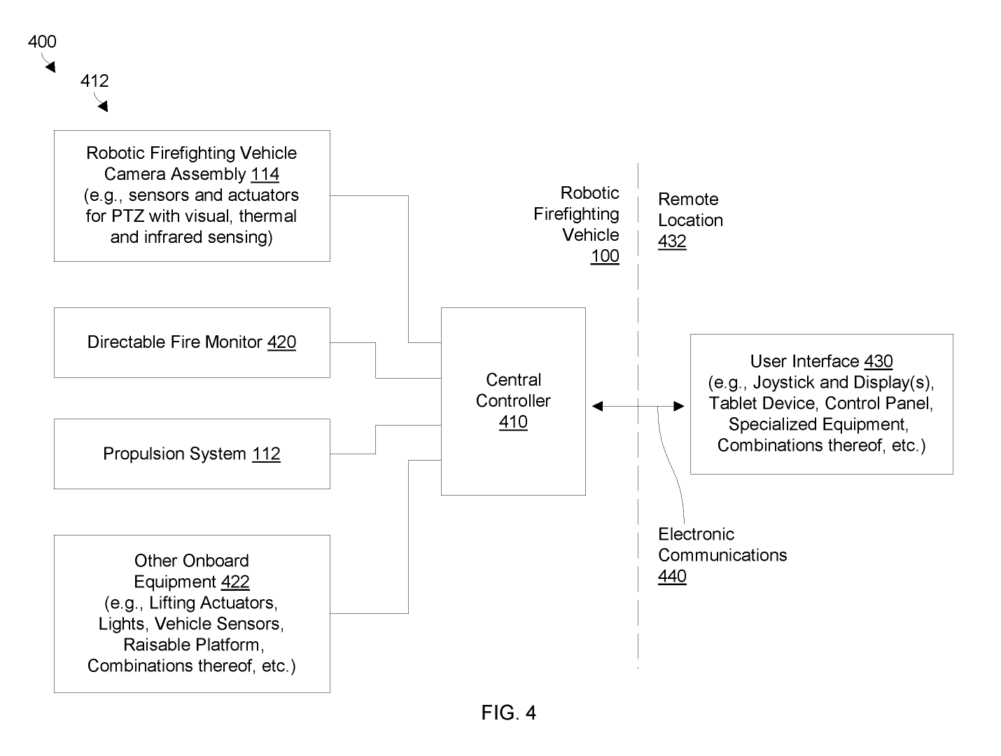

In some arrangements, the camera housing 200 defines a housing footprint which is occupied by the camera housing 200 when the base 210 of the camera housing 200 is mounted to the robotic firefighting vehicle body 110. Additionally, the debris shield 204 includes a metallic scaffold 220 which extends over the camera housing 200 when the debris shield 204 positions over the movable camera 202 and the camera housing 200 to protect against debris damage. The metallic scaffold 220 defines a metallic scaffold footprint which is larger than the housing footprint to robustly and reliably protect against falling or flying debris. Further details of the robotic firefighting vehicle 100 will now be provided with reference to FIG. 4.

FIG. 4 is a schematic view 400 of certain componentry of the robotic firefighting vehicle 100 in accordance with one or more embodiments. As shown, the vehicle 100 includes a central controller 410 and various equipment 412 which electrically couples with the central controller 410. Such equipment 412 includes the robotic firefighting vehicle camera assembly 114, a directable fire monitor 420, the propulsion system 112, and other onboard equipment 422.

The central controller 410 is constructed and arranged to communicate with a user interface 430 residing at a remote location 432. In particular, the central controller 410 and the user interface 430 may include respective transceiver circuits enabling the central controller 410 and the user interface 430 to exchange electronic communications 440. Along these lines, the central controller 410 may send wireless signals (e.g., acquired data, status, etc.) to the user interface 430 and receive wireless signals (e.g., steering commands, commands to aim the directable fire monitor 420, commands to operate the movable camera 202 of the robotic firefighting vehicle camera assembly 114, combinations thereof, etc.) from the user interface 430.

The robotic firefighting vehicle camera assembly 114 is constructed and arranged to exchange information with the user interface 430 through the central controller 410. Along these lines, the user interface 430 provides commands to operate the movable camera 202 and acquires camera data from the movable camera 202 (also see FIG. 3). For example, the movable camera 202 may be equipped with a set of sensors (e.g., for visual sensing, thermal sensing, infrared sensing, combinations thereof, etc.) and a set of actuators to aim the set of sensors in different directions within a large viewing range.

In some arrangements, such commands direct the movable camera 202 to perform certain operations such as panning, tilting, and/or zooming. Accordingly, the movable camera 202 is able to capture more image data than that from just a fixed forward-facing camera which merely provides a simple front view. Rather, the movable camera 202 is able to capture image data from the left and right sides of the vehicle 100, above the vehicle 100, in the distance, combinations thereof, etc. Such information is then provided to the central controller 410 which relays the information to the user interface 430 for enhanced remote situational awareness.

In some arrangements, the movable camera 202 is equipped for different types of sensing such as the ability to capture visual images, thermal images, and infrared images. Accordingly, the user interface 430 is able to access more than simply a visual image which can help firefighting operations (e.g., to identify people, for night vision, to spot overheating equipment and other heat sources, etc.).

The directable (or targetable) fire monitor 420 is constructed and arranged to deliver fluid (e.g., water, foam, etc.) to a burning target. Along these lines, the directable fire monitor 420 receives commands from the user interface 430 through the central controller 410 to control valve operation, actuator operation, etc. Accordingly, the directable fire monitor 420 is able to direct fluid toward a burning target regardless of the direction of the movable camera 202 or the vehicle 100.

The propulsion system 112 is constructed and arranged to maneuver the vehicle 100 within an environment 120 (also see FIG. 1). Along these lines, the propulsion system 112 receives commands from the user interface 430 through the central controller 410 to control speed, steering, transmission (e.g., forward/reverse), etc. Accordingly, the user interface 430 is able to drive the vehicle 100 in a vehicle direction regardless of the direction of the movable camera 202 or the directable fire monitor 420.

The other onboard equipment 422 refers to other componentry which is electrically connected with the central controller 410. Such componentry may include actuators (e.g., to operate a plow or lift), lights, vehicle sensors, a raisable platform, one or more sprayers, additional cameras, and so on. Such componentry may be managed by the user interface 430 through the central controller 410.

When a raisable platform is available, the robotic firefighting vehicle camera assembly 114 may mounted to the raisable platform. Accordingly, if there is something that is blocking the view of the movable camera 202, the height of the raisable platform can be changed to improve the view. For example, the platform can be raised to elevate the movable camera 202 over a spray from the fire monitor 420.

The user interface 430 includes specialized equipment for user input/output (I/O). Along these lines, the user interface 430 may include a joystick (e.g., for enhanced directional input), a keyboard (e.g., for text-based input), a mouse, combinations thereof, etc. The user interface 430 may further include one or more displays or screens which output the camera data from the movable camera 202 (e.g., live video, thermal imaging, infrared imaging, combinations thereof, etc.).

In some arrangements, the user interface 430 includes a tablet-style device having a touch screen. Accordingly, the user interface 430 itself is mobile for increased flexibility.

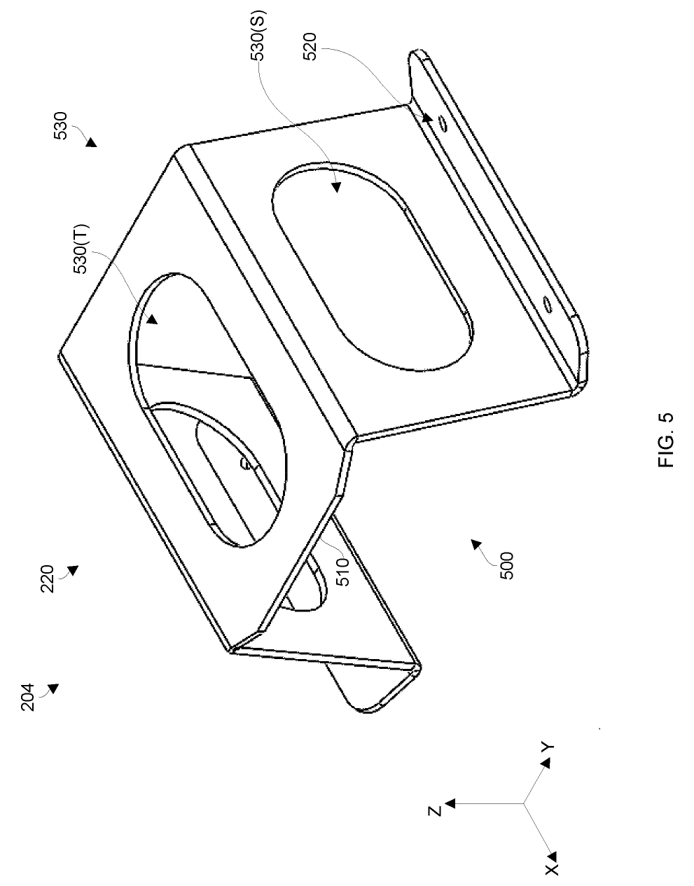

At this point, it should be understood that, in response to commands from the user interface 430, the central controller 410 may operate the various equipment 412 independently of each other (e.g., simultaneously point the various equipment 412 in different directions). Along these lines, the user interface 430 may steer the vehicle 100 in a first direction (e.g., to avoid an obstacle), aim the fire monitor 420 in a second direction (e.g., to apply fluid to a burning object), and operate the movable camera 202 to capture images in a third direction (e.g., to obtain an overhead or side view) all at the same time. Such operability enables more effective use of the vehicle 100 (e.g., the user interface 430 is able to obtain camera data from directions that are different from the direction that the vehicle 100 and/or the fire monitor 420 are/is pointed in. Further details of the debris shield 204 will now be provided with reference to FIGS. 5-8.

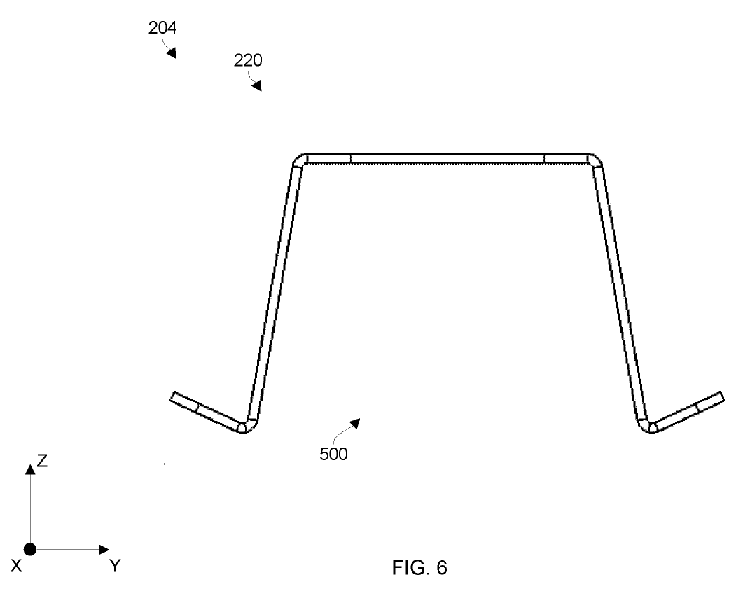

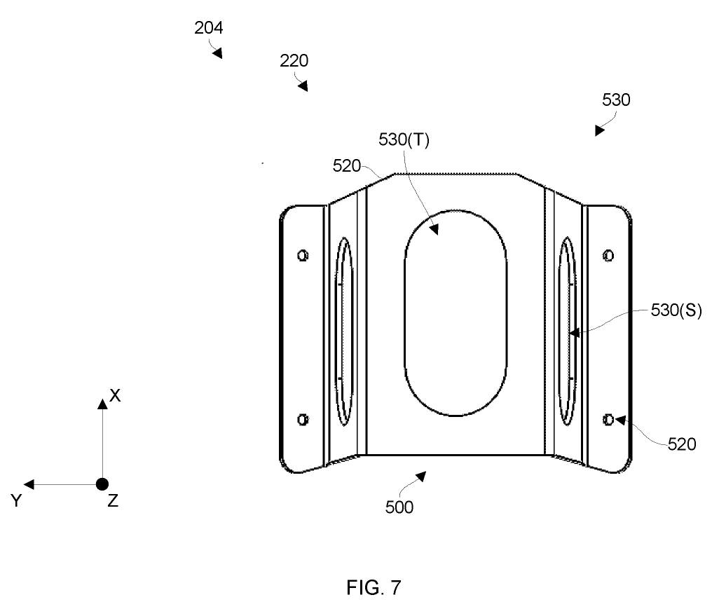

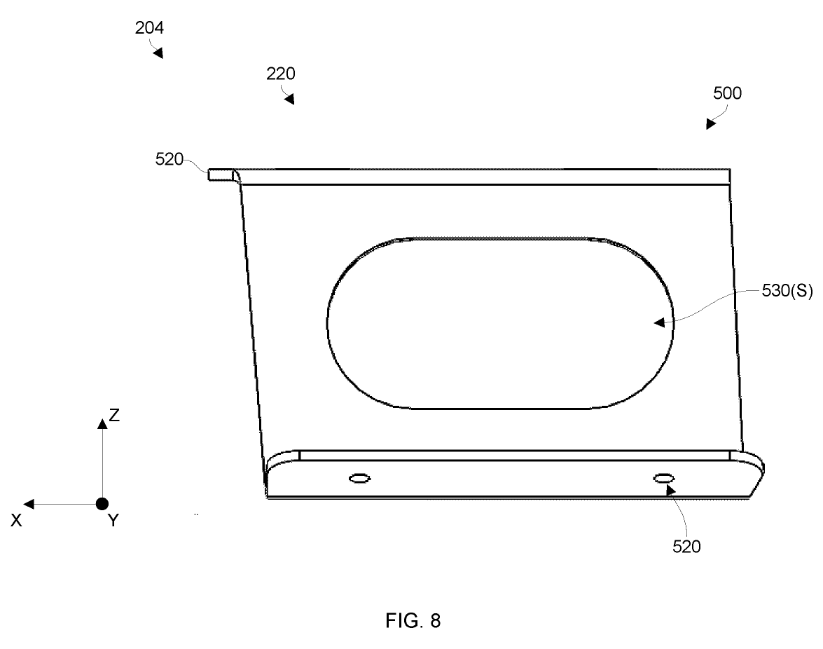

FIGS. 5-8 show certain details of the debris shield 204 in accordance with certain embodiments. FIG. 5 is a perspective view of the debris shield 204. FIG. 6 is a front view of the debris shield 204. FIG. 7 is a top view of the debris shield 204. FIG. 8 is a side view of the debris shield 204.

As shown in FIGS. 5-8 and as mentioned earlier, the debris shield 204 includes a metallic scaffold 220 that serves as a durable, rigid structure which protects the camera housing 200 and the movable camera 202 from damage due to falling or flying debris. In some arrangements, the metallic scaffold 220 may be formed from sheet metal stock which has been pressed, punched, bent, welded, coated, combinations thereof, etc. In other arrangements, the metallic scaffold 220 is made from aluminum or similar materials for strength, durability, weight considerations, manufacturability, etc.

Along these lines, the metallic scaffold 220 may define or include a variety of portions or sections to define the shape of the metallic scaffold 220. For example, the metallic scaffold 220 may include a top section, side sections that extend in a general downward direction from the top section, and bottom sections which contact the robotic firefighting vehicle body 110 (also see FIGS. 1 and 2). In some arrangements, the bottom sections may not extend horizontally but at angles to accommodate various contours of the robotic firefighting vehicle body 110.

In some arrangements, the metallic scaffold 220 does not include front or rear sections but instead defines openings 500 which enable the movable camera 202 to capture views of what is in front and/or at the rear of the robotic firefighting vehicle 100 without the views being hindered or otherwise obstructed by the debris shield 204 (e.g., see FIG. 4). Accordingly, such openings 500 enable the movable camera 202 to pan or tilt over a wide area for optimal viewability in front and/or at the rear of the robotic firefighting vehicle 100.

In some arrangements, part of the metallic scaffold 220 (e.g., the top section) defines a lip 510 over a front opening 500. Such a lip 510 provides additional debris protection to the front sides of the camera housing 200 and the movable camera 202.

In some arrangements, part of the metallic scaffold 220 (e.g., the bottom sections) define mounting holes 520 for hardware. Along these lines, the debris shield 204 may further include mounting hardware (e.g., bolts, washers, etc.) to fasten the metallic scaffold 220 to the robotic firefighting vehicle body 110.

As best seen in FIGS. 5, 7, and 8, the metallic scaffold 220 further defines a plurality of apertures/windows (or viewing openings) 530 through which light and water are allowed to pass to reach the translucent cover of the camera housing 212 (FIGS. 1 and 2). Along these lines, side sections of the metallic scaffold 220 define side apertures 530(S) (e.g., a left-side aperture on a left-side section, and a right-side aperture on a right-side section). Additionally, a top section defines a top aperture 530(T). Such apertures 530 enable the movable camera 202 to obtain images of the environment as well as allows fluid (e.g., water, foam, etc.) provided by the robotic firefighting vehicle 100 to contact and run off the camera housing 200 to provide additional protection to the firefighting vehicle camera assembly 114.

In some arrangements, the camera housing 200 defines a housing footprint (e.g., an area in the X-Y plan in FIG. 3), and the debris shield 204 defines a shielding footprint (e.g., another area in the X-Y plan in FIGS. 5 through 8) which is larger than the housing footprint. Along these lines, the metallic scaffold 220 defines a metallic scaffold footprint which is wider and longer than the housing footprint. Accordingly, the movable camera 202 is able to derive some protection by being housed within the camera housing 200, but additional protection from residing completely under the debris shield 204.

At this point, it should be understood that, while the camera housing 200 and the debris shield 204 protects the movable camera 202 against damage, the movable camera 202 is nevertheless able to obtain camera data across a wide range of directions (e.g., from the front, sides, and above the vehicle 100) and convey that camera data to the user interface 430 through the central controller 410 (also see FIG. 4). Such operability enables the vehicle 100 to operate more effectively than a conventional vehicle which is limited to using a fixed forward-facing camera which only views what is in the front.

As described above, certain techniques involve utilizing a robotic firefighting vehicle camera assembly 114 having a movable camera 202. Along these lines, such a movable camera 202 may be coupled to a body 110 of a robotic firefighting vehicle 100 and protected by a debris shield 204. For example, the movable camera 202 may be provisioned with PTZ operability and put in place of a fixed forward-facing camera. Accordingly, the movable camera 202 is able to provide views to the left or right of the vehicle 100 (e.g., via panning) thus enabling a user interface to provide a view of what is off to the side without needed to change the direction of the vehicle 100. Additionally, the movable camera 202 is able to view what is above the vehicle 100 or on the ground just in front of the vehicle 100 (e.g., via tilting) thus enabling the user interface 430 to provide views of areas such as a ceiling, a tree limb, etc. immediately above the vehicle 100 while receiving protection from the debris shield 204, or pits/holes/trenches/etc. in the ground immediately in front of the vehicle 100, and so on. Furthermore, the movable camera 202 is able to view more distant details that could be otherwise missed (e.g., via zooming) such as people, hazardous materials, various problematic structures, combinations thereof, etc. beyond the immediate foreground. As a result, the robotic firefighting vehicle camera assembly 114 enhances operation of the robotic firefighting vehicle 100.

While various embodiments of the present disclosure have been particularly shown and described, it will be understood by those skilled in the art that various changes in form and details may be made therein without departing from the spirit and scope of the present disclosure. Such modifications and enhancements are intended to belong to various embodiments of the disclosure.

It should be appreciated that, without a movable camera, conventional robotic firefighting vehicles are limited to fixed position cameras where visibility is restricted to the field of view of the cameras. In order to see something that is outside of the field of view, such a robotic firefighting vehicle has to maneuver in a way that positions the desired target within the field of view of the camera.

Additionally, suppose that the conventional robotic firefighting vehicle is provisioned with multiple fixed positioned cameras (e.g., on the front and rear of the vehicles). Unfortunately, the views provided by the cameras are limited to the direction that the vehicle is pointed in.

Furthermore, suppose that a camera is positioned on the fire monitor that can be aimed toward burning objects. Unfortunately, the views are still significantly restricted because the monitor has a limited range of freedom and is mostly focused towards the front of the vehicle.

Without the improvements disclosed herein, there is no reliable way of viewing to the side or above the conventional robotic firefighting vehicle (e.g., to view the sides, the user would have to steer the conventional robotic firefighting vehicle to the side to see with the front or rear facing cameras). Moreover, there is also no reliable way to view what's above the robot without aiming the monitor up, but that would limit the monitor’s water delivery capabilities.

In accordance with certain embodiments, a pan, tilt, zoom (PTZ) camera is utilized on a robotic firefighting vehicle. A PTZ camera is a camera with the ability to pan, tilt, and zoom to allow it to move the field of view of the camera for greater visibility. Utilizing the PTZ camera on a firefighting robot increases it’s visibility beyond fixed placement cameras.

Moreover, in some embodiments, a protective cover (or shield) protects the PTZ camera. Such a cover protects the PTZ camera but nevertheless allows for improved viewing range beyond that which is provided by a fixed position camera.

In accordance with certain embodiments, a camera device allows a user to view in a half sphere window above the robot. The camera can be aimed using a joystick on the controller to have more freedom to look around and have more situation awareness.

In accordance with certain embodiments, the camera is equipped with standard imaging, thermal imaging, and IR imaging. Such features provide increased situation awareness capabilities. Protective cover w/ windows to shield the device while minimally blocking the field of view.

The integration of a PTZ camera with a robotic firefighting vehicle enables inclusion of a streaming video feed from the camera to the vehicle controller. The cameras ability to pan, tilt and zoom can all be controlled from the controller as well. This allows the function of the camera without line of sight to the vehicle.

In some arrangements, there is also a protective cover for the camera to reduce risk of debris from causing damage. This cover is a piece of bent metal that goes over the camera and is bolted to the lid. The cover also has viewport holes to allow for the camera to see out. The holes are sized in such a way that balance the protection of the camera and retain as much visibility as possible.

The improvements disclosed herein can be included in any application that needs increased situation awareness capabilities. For example, such improvements can be further used in a military vehicle, a SWAT-style robot, and any other vehicle that needs increased situation awareness capabilities.

The description herein provides examples for the purposes of understanding and is not intended to limit the invention or the application and uses of the same. Furthermore, there is no intention to be bound by any expressed or implied theory presented herein.

Directional references such as “top,” “bottom,” “left,” “right,” “above,” “below,” and so forth, unless otherwise stated, are not intended to require any preferred orientation and are made with reference to the orientation of the corresponding figure or figures for purposes of illustration.

It will be appreciated that the steps of various processes described herein are non-limiting examples of suitable processes according to embodiments and are for the purposes of illustration. Systems and devices according to embodiments herein may use any suitable processes including those that omit steps described above, perform those steps and similar steps in different orders, and the like. It will also be appreciated that well-known features may be omitted for clarity.

Certain embodiments are directed to a robotic firefighting vehicle camera assembly. Such an assembly includes a camera housing constructed and arranged to attach to a body of a robotic firefighting vehicle and a movable camera coupled with the camera housing. The movable camera is constructed and arranged to move relative to the camera housing. The assembly further includes a debris shield constructed and arranged to position over the movable camera and the camera housing to protect against debris damage when the camera housing attaches to the body of the robotic firefighting vehicle.

Other embodiments are directed to a robotic firefighting vehicle which includes a robotic firefighting vehicle body, and a propulsion system coupled with the robotic firefighting vehicle body. The propulsion system is constructed and arranged to provide propulsion to the robotic firefighting vehicle. The robotic firefighting vehicle further includes a robotic firefighting vehicle camera assembly coupled with the robotic firefighting vehicle body. The robotic firefighting vehicle camera assembly includes:
(A) a camera housing constructed and arranged to attach to the robotic firefighting vehicle body,
(B) a movable camera coupled with the camera housing, the movable camera being constructed and arranged to move relative to the camera housing, and
(C) a debris shield constructed and arranged to position over the movable camera and the camera housing to protect against debris damage when the camera housing attaches to the robotic firefighting vehicle body.

In accordance with one or more embodiments, the camera housing includes a base constructed and arranged to mount to the robotic firefighting vehicle body, and a translucent cover coupled with the base. The base and the translucent cover enclose the movable camera.

In accordance with one or more embodiments, the camera housing defines a housing footprint which is occupied by the camera housing when the base of the camera housing is mounted to the robotic firefighting vehicle body. Additionally, the debris shield includes a metallic scaffold which extends over the camera housing when the debris shield is positioned over the movable camera and the camera housing to protect against debris damage. The metallic scaffold defines a metallic scaffold footprint which is larger than the housing footprint.

In accordance with one or more embodiments, the debris shield defines a plurality of openings (or windows) through which light and water are allowed to pass to reach the translucent cover of the camera housing. Additionally, the movable camera is constructed and arranged to provide PTZ operability within the camera housing to enable the movable camera to capture images through the plurality of openings defined by the debris shield.

In accordance with one or more embodiments, the robotic firefighting vehicle further includes a controller disposed within the robotic firefighting vehicle body. The controller is constructed and arranged to provide propulsion system control to maneuver the robotic firefighting vehicle within an environment, and camera assembly control to capture images of the environment.

In accordance with one or more embodiments, the controller is equipped to simultaneously maneuver the robotic firefighting vehicle in a vehicle direction and aim the movable camera of the robotic firefighting vehicle camera assembly in a camera direction that is different from the vehicle direction in response to a set of controller commands.

In accordance with one or more embodiments, the robotic firefighting vehicle further includes a fire monitor coupled with the robotic firefighting vehicle body. Additionally, the controller is further constructed and arranged to provide fire monitor control to control fluid delivery from the fire monitor.

In accordance with one or more embodiments, the controller is equipped to simultaneously point the fire monitor in a monitor direction and aim the movable camera of the robotic firefighting vehicle camera assembly in a camera direction that is different from the monitor direction in response to a set of controller commands.

In accordance with one or more embodiments, the controller is equipped to independently (and simultaneously) maneuver the robotic firefighting vehicle in a vehicle direction, point the fire monitor in a monitor direction, and aim the movable camera of the robotic firefighting vehicle camera assembly in a camera direction. Additionally, the vehicle direction, the monitor direction, and the camera direction are different directions in response to a set of controller commands sent to the controller from a remote joystick.

In accordance with one or more embodiments, the movable camera includes a set of sensors and a set of actuators to aim the set of sensors.

In accordance with one or more embodiments, the set of sensors is constructed and arranged to provide visual images, thermal images, and infrared images.

In accordance with one or more embodiments, the set of actuators is constructed and arranged to support PTZ operability.

In accordance with one or more embodiments, the set of sensors is constructed and arranged to provide visual images, thermal images, and infrared images. Additionally, the set of actuators is constructed and arranged to support PTZ operability while the set of sensors provides images.

In accordance with one or more embodiments, the robotic firefighting vehicle body includes a main section and a raisable platform constructed and arranged to transition between different elevations relative to the main section. Additionally, the camera housing attaches to the raisable platform of the robotic firefighting vehicle body.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Also, the foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematics and component features shown in the figures depict one exemplary arrangement of elements, additional intervening elements, devices, features, or components may be present in one or more other embodiments of the depicted subject matter.

Those skilled in the art will therefore understand that various changes in form and detail may be made to the embodiments disclosed herein without departing from the scope of the following claims.

What is claimed is:

1. A robotic firefighting vehicle, comprising:
a robotic firefighting vehicle body;
a propulsion system coupled with the robotic firefighting vehicle body, the propulsion system being constructed and arranged to provide propulsion to the robotic firefighting vehicle; and
a robotic firefighting vehicle camera assembly coupled with the robotic firefighting vehicle body, the robotic firefighting vehicle camera assembly including:
a camera housing constructed and arranged to attach to the robotic firefighting vehicle body,
a movable camera coupled with the camera housing, the movable camera being constructed and arranged to move relative to the camera housing, and
a debris shield constructed and arranged to position over the movable camera and the camera housing to protect against debris damage when the camera housing attaches to the robotic firefighting vehicle body.

2. The robotic firefighting vehicle of claim 1 wherein the camera housing includes:
a base constructed and arranged to mount to the robotic firefighting vehicle body, and
a translucent cover coupled with the base, the base and the translucent cover enclosing the movable camera.

3. The robotic firefighting vehicle of claim 2 wherein the camera housing defines a housing footprint which is occupied by the camera housing when the base of the camera housing is mounted to the robotic firefighting vehicle body; and
wherein the debris shield includes a metallic scaffold which extends over the camera housing when the debris shield is positioned over the movable camera and the camera housing to protect against debris damage, the metallic scaffold defining a metallic scaffold footprint which is larger than the housing footprint.

4. The robotic firefighting vehicle of claim 2 wherein the debris shield defines a plurality of openings through which light and water are allowed to pass to reach the translucent cover of the camera housing; and
wherein the movable camera is constructed and arranged to provide pan, tilt, zoom (PTZ) operability within the camera housing to enable the movable camera to capture images through the plurality of openings defined by the debris shield.

5. The robotic firefighting vehicle of claim 1, further comprising:
a controller disposed within the robotic firefighting vehicle body, the controller being constructed and arranged to provide propulsion system control to maneuver the robotic firefighting vehicle within an environment, and camera assembly control to capture images of the environment.

6. The robotic firefighting vehicle of claim 5 wherein the controller is equipped to simultaneously maneuver the robotic firefighting vehicle in a vehicle direction and aim the movable camera of the robotic firefighting vehicle camera assembly in a camera direction that is different from the vehicle direction in response to a set of controller commands.

7. The robotic firefighting vehicle of claim 5, further comprising:
a fire monitor coupled with the robotic firefighting vehicle body; and
wherein the controller is further constructed and arranged to provide fire monitor control to control fluid delivery from the fire monitor.

8. The robotic firefighting vehicle of claim 7 wherein the controller is equipped to simultaneously point the fire monitor in a monitor direction and aim the movable camera of the robotic firefighting vehicle camera assembly in a camera direction that is different from the monitor direction in response to a set of controller commands.

9. The robotic firefighting vehicle of claim 7 wherein the controller is equipped to independently maneuver the robotic firefighting vehicle in a vehicle direction, point the fire monitor in a monitor direction, and aim the movable camera of the robotic firefighting vehicle camera assembly in a camera direction; and
wherein, simultaneously, the vehicle direction, the monitor direction, and the camera direction are different directions in response to a set of controller commands sent to the controller from a remote joystick.

10. The robotic firefighting vehicle of claim 5 wherein the movable camera includes a set of sensors and a set of actuators to aim the set of sensors.

11. The robotic firefighting vehicle of claim 10 wherein the set of sensors is constructed and arranged to provide visual images, thermal images, and infrared images.

12. The robotic firefighting vehicle of claim 10 wherein the set of actuators is constructed and arranged to support pan, tilt, zoom (PTZ) operability.

13. The robotic firefighting vehicle of claim 10 wherein the set of sensors is constructed and arranged to provide visual images, thermal images, and infrared images; and
wherein the set of actuators is constructed and arranged to support pan, tilt, zoom (PTZ) operability while the set of sensors provides images.

14. The robotic firefighting vehicle of claim 1 wherein the robotic firefighting vehicle body includes a main section and a raisable platform constructed and arranged to transition between different elevations relative to the main section; and
wherein the camera housing attaches to the raisable platform of the robotic firefighting vehicle body.

15. A robotic firefighting vehicle camera assembly, comprising:
a camera housing constructed and arranged to attach to a body of a robotic firefighting vehicle;
a movable camera coupled with the camera housing, the movable camera being constructed and arranged to move relative to the camera housing; and
a debris shield constructed and arranged to position over the movable camera and the camera housing to protect against debris damage when the camera housing attaches to the body of the robotic firefighting vehicle.

16. The robotic firefighting vehicle camera assembly of claim 15 wherein the camera housing includes:
a base constructed and arranged to mount to the body of the robotic firefighting vehicle, and
a translucent cover coupled with the base, the base and the translucent cover enclosing the movable camera.

17. The robotic firefighting vehicle camera assembly of claim 16 wherein the camera housing defines a housing footprint which is occupied by the camera housing when the base of the camera housing is mounted to the body of the robotic firefighting vehicle; and
wherein the debris shield includes a metallic scaffold which extends over the camera housing when the debris shield is positioned over the movable camera and the camera housing to protect against debris damage, the metallic scaffold defining a metallic scaffold footprint which is larger than the housing footprint.

18. The robotic firefighting vehicle camera assembly of claim 16 wherein the debris shield defines a plurality of openings through which light and water are allowed to pass to reach the translucent cover of the camera housing; and
wherein the movable camera is constructed and arranged to provide pan, tilt, zoom (PTZ) operability within the camera housing to enable the movable camera to capture images through the plurality of openings defined by the debris shield.
